(19) United States
(12) Patent Application Publication
(10) Pub. No.: US 2013/0252315 A1
(43) Pub. Date: Sep. 26, 2013

(54) STABILIZED, LIQUID, ENZYME-CONTAINING SURFACTANT PREPARATION

(71) Applicant: Henkel AG & Co. KGaA, Duesseldorf (DE)

(72) Inventors: Timothy O'Connell, Duesseldorf (DE); Susanne Tondera, Duesseldorf (DE); Thomas Weber, Dormagen (DE)

(73) Assignee: Henkel AG & Co. KGaA, Duesseldorf (DE)

(21) Appl. No.: 13/893,528

(22) Filed: May 14, 2013

Related U.S. Application Data
(63) Continuation of application No. PCT/EP2011/069168, filed on Oct. 31, 2011.

(30) Foreign Application Priority Data
Nov. 15, 2010 (DE) 10 2010 043 934.7

(51) Int. Cl. C11D 3/386

(52) U.S. Cl. CPC C11D 3/38663
USPC 435/264; 510/393

(57) ABSTRACT

The aim of the invention is to stabilize a hydrolytic enzyme in a liquid surfactant preparation. Said aim is achieved by using a component stabilizing the hydrolytic enzyme, said component comprising boric acid, propylene glycol and a phenylboronic acid derivative having the structural formula (I) in which R is hydrogen, a hydroxyl group, a C1-C6 alkyl group, a substituted C1-C6 alkyl group, a C1-C6 alkenyl group or a substituted C1-C6 alkenyl group.

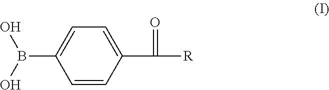

### FIELD OF THE INVENTION

The present invention generally relates to liquid, enzyme-containing surfactant preparations as used, for example, in washing, cleaning or disinfecting, and more particularly relates to such a liquid surfactant preparation in which a hydrolytic enzyme is stabilized. The invention furthermore relates to uses of enzyme stabilizers and methods in which enzymes are used. Furthermore, the invention relates to enzyme preparations stabilized in this way.

### BACKGROUND OF THE INVENTION

Problems concerning the storage stability of enzyme-containing surfactant preparations, e.g. of washing or cleaning agents or disinfectants, are known from the prior art. These problems are particularly pronounced in the case of liquid, enzyme-containing surfactant preparations, e.g. liquid washing or cleaning agents. After just a short time, they lose a considerable degree of enzymatic, in particular hydrolytic, activity. The surfactant preparation, e.g. the washing or cleaning agent or disinfectant, then no longer displays an optimum cleaning performance. A goal in the development of enzyme-containing surfactant preparations therefore lies in stabilizing the enzymes contained and protecting them from denaturing and/or decomposition or degradation, particularly during storage and/or during the use of the surfactant preparation. In this respect, hydrolytic enzymes and especially lipases or proteases are of particular interest.

In addition to other established enzyme stabilizers, such as e.g. propylene glycol, boric acid and boric acid derivatives occupy a prominent position among enzyme stabilizers that are effective even in comparatively low concentrations in surfactant preparations. However, boric acids and borates have the disadvantage that they form undesirable by-products with other ingredients of a surfactant preparation, in particular washing or cleaning agent or disinfectant ingredients, so that these are no longer available in the respective agents for the desired cleaning purpose, or even remain as a contaminant, e.g. on the material being washed. Furthermore, boric acids and borates are increasingly being viewed as disadvantageous from an environmental point of view.

Furthermore, boronic acid derivatives are proposed in the prior art as enzyme stabilizers. For example, the international patent application WO 96/21716 A1 discloses that boric or boronic acid derivatives acting as protease inhibitors are suitable for stabilizing enzymes in liquid preparations, including in washing and cleaning agents. A selection of boronic acid derivatives, including 4-formylphenylboronic acid, as stabilizers is also disclosed in the international patent application WO 96/41859 A1. Such compounds are furthermore used in the international patent application WO 2006/045310 for enzyme stabilizing, but in solid washing agent bars. However, no combinations of enzyme stabilizers for liquid surfactant preparations, as are described below, can be taken from the prior art.

The present invention is based on the object of providing a liquid surfactant preparation with stabilized hydrolytic enzymes. Preferably, the surfactant preparation should contain less boric acid as an enzyme stabilizer.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A liquid surfactant preparation comprising a hydrolytic enzyme and a component stabilizing the hydrolytic enzyme, wherein the component stabilizing the hydrolytic enzyme comprises boric acid, propylene glycol and a phenylboronic acid derivative with the structural formula

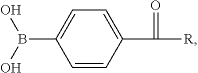

in which R denotes hydrogen, a hydroxyl group, a C₁-C₆ alkyl group, a substituted C₁-C₆ alkyl group, a C₁-C₆ alkenyl or a substituted C₁-C₆ alkenyl group.

Use of a component which comprises boric acid, propylene glycol and a phenylboronic acid derivative with the structural formula

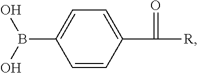

in which R denotes hydrogen, a hydroxyl group, a C₁-C₆ alkyl group, a substituted C₁-C₆ alkyl group, a C₁-C₆ alkenyl or a substituted C₁-C₆ alkenyl group, for stabilizing a hydrolytic enzyme in a liquid surfactant preparation.

A method, in particular a washing or cleaning method, in which a hydrolytic enzyme, in particular one that is selected from the group consisting of protease, amylase, cellulase, glycosidase, hemicellulase, mannanase, xylanase, xyloglucanase, xanthanase, pectinase, β-glucosidase, carrageenase, lipase or mixtures thereof, in particular a lipase, is stabilized in a washing liquor by a component stabilizing the hydrolytic enzyme, which comprises boric acid, propylene glycol and a phenylboronic acid derivative with the structural formula

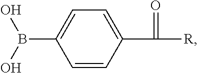

in which R denotes hydrogen, a hydroxyl group, a C₁-C₆ alkyl group, a substituted C₁-C₆ alkyl group, a C₁-C₆ alkenyl or a substituted C₁-C₆ alkenyl group.

A liquid enzyme preparation comprising a hydrolytic enzyme and a component stabilizing the hydrolytic enzyme, wherein the component stabilizing the hydrolytic enzyme comprises boric acid, propylene glycol and a phenylboronic acid derivative with the structural formula

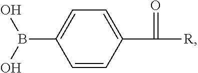

in which R denotes hydrogen, a hydroxyl group, a C₁-C₆ alkyl group, a substituted C₁-C₆ alkyl group, a C₁-C₆ alkenyl or a substituted C₁-C₆ alkenyl group.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention provides a liquid surfactant preparation comprising a hydrolytic enzyme and a component stabilizing the hydrolytic enzyme, wherein the component stabilizing the hydrolytic enzyme comprises boric acid, propylene glycol and a phenylboronic acid derivative with the structural formula

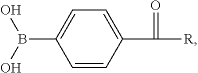

in which R denotes hydrogen, a hydroxyl group, a C₁-C₆ alkyl group, a substituted C₁-C₆ alkyl group, a C₁-C₆ alkenyl or a substituted C₁-C₆ alkenyl group.

It has been found that such a combination of boric acid, propylene glycol and an appropriate phenylboronic acid derivative keeps a hydrolytic enzyme, in particular a lipase or a protease and among these in particular a lipase, advantageously stable in a liquid surfactant preparation, e.g. in a liquid washing or cleaning agent or disinfectant. The combination of these compounds therefore makes it possible to use the stabilizers in preferred surfactant preparations according to the invention in a lower overall concentration in order to create an adequate enzyme stabilizing effect. Furthermore, the possibility of being able to use less boric acid as an enzyme stabilizer in preferred surfactant preparations according to the invention is opened up. In other preferred embodiments according to the invention, it is possible to create an improved enzyme stabilizing effect with such an enzyme-stabilizing component.

Furthermore, these compounds have good water solubility. They can therefore be readily incorporated into liquid surfactant preparations, in particular into liquid washing or cleaning agents or disinfectants or into a washing or cleaning liquor formed by such a surfactant preparation, or readily applied therein.

Moreover, in preferred embodiments according to the invention, precipitation during storage is reduced or completely avoided. In other preferred embodiments according to the invention, the combined action of boric acid, propylene glycol and an appropriate phenylboronic acid derivative results in synergistic enzyme stabilizing. This means improved enzyme stabilizing through the combination of the compounds in comparison with enzyme stabilizing by any one of these compounds individually and also in comparison with the sum of the individual performances of the compounds in terms of enzyme stabilizing.

In a preferred embodiment, a surfactant preparation according to the invention is characterized in that the residue R in the phenylboronic acid derivative is a C₁-C₆ alkyl group and among these, more preferably, CH₃, CH₃CH₂ or CH₃CH₂CH₂. In another preferred embodiment, a surfactant preparation according to the invention is characterized in that the residue R in the phenylboronic acid derivative is hydrogen.

In a most particularly preferred embodiment of the invention, the surfactant preparation according to the invention is characterized in that the phenylboronic acid derivative is a 4-formlyphenylboronic acid (4-FBPA). It is given in the following formula:

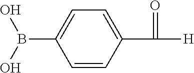 [SMILES: O=Cc1ccc(B(O)O)cc1]

Phenylboronic acid derivatives according to the invention can furthermore have other chemical modifications on the phenyl ring, and in particular they can contain one or more methyl, amino, nitro, chloro, fluoro, bromo, hydroxyl, formyl, ethyl, acetyl, t-butyl, anisyl, benzyl, trifluoroacetyl, N-hydroxysuccinimide, t-butyloxycarbonyl, benzoyl, 4-methylbenzyl, thioanizyl, thiocresyl, benzyloxymethyl, 4-nitrophenyl, benzyloxycarbonyl, 2-nitrobenzoyl, 2-nitrophenylsulfenyl, 4-toluenesulfonyl, pentafluorophenyl, diphenylmethyl, 2-chlorobenzyloxycarbonyl, 2,4,5-trichlorophenyl, 2-bromobenzyloxycarbonyl, 9-fluorenylmethyloxycarbonyl, triphenylmethyl, 2,2,5,7,8-pentamethylchroman-6-sulfonyl residues or groups or combinations thereof.

All compounds which are provided within the framework of the present invention as part of the component stabilizing the hydrolytic enzyme can be present in the surfactant preparation in all protonated or deprotonated forms. Furthermore, all such compounds, in particular their deprotonated forms, can be associated with cations. Preferred cations in this respect are monovalent or polyvalent, in particular divalent, cations, in particular Na ions (Na⁺), K ions (K⁺), Li ions (Li⁺), Ca ions (Ca²⁺), Mg ions (Mg²⁺), Mn ions (Mn²⁺) and Zn ions (Zn²⁺). Particularly preferred are Na ions (Na⁺).

The component stabilizing the hydrolytic enzyme can consist exclusively of the aforementioned compounds, so that the component stabilizing the hydrolytic enzyme is a combination of boric acid, propylene glycol and appropriate phenylboronic acid derivative. Alternatively, the component stabilizing the hydrolytic enzyme can encompass further compounds, so that the combination of boric acid, propylene glycol and appropriate phenylboronic acid derivative is a part of the component stabilizing the hydrolytic enzyme.

In a surfactant preparation according to the invention, boric acid is preferably contained in a quantity of from 0.05 to 5.5 wt. % and increasingly preferably from 0.075 to 4.5 wt. %, from 0.09 to 3.5 and from 0.1 to 2.49 wt. %.

Propylene glycol is contained in a surfactant preparation according to the invention preferably in a quantity of from 0.000001 to 10 wt. % and increasingly preferably from 0.01 to 9.5 wt. %, from 1 to 9 wt. %, from 1.5 to 8.5 wt. % and from 2 to 8 wt. %.

The phenylboronic acid derivative is contained in a surfactant preparation according to the invention preferably in a quantity of from 0.001 to 0.08 wt. % and increasingly preferably from 0.003 to 0.06 wt. %, from 0.005 to 0.05 wt. %, from 0.007 to 0.03 wt. % and from 0.009 to 0.01 wt. %.

A hydrolytic enzyme is a hydrolase (E.C. 3.X.X.X) and thus an enzyme which hydrolytically cleaves esters, ethers, peptides, glycosides, acid anhydrides or C—C bonds in a reversible reaction. The hydrolytic enzyme therefore catalyzes the hydrolytic cleavage of substances according to A-B+H₂O⇄AH+B—OH. Hydrolases form the third main class of the EC classification of enzymes. The EC numbers (“Enzyme Commission numbers”) form a numerical classification system for enzymes. Each EC number consists of four digits separated by periods, the first figure denoting one of the six main classes of enzymes and representing hydrolases as E.C. 3.X.X.X, corresponding to the third main class. Representatives of these are proteases, peptidases, nucleases, phosphatases, glycosidases and esterases.

The hydrolytic enzyme is contained in the liquid surfactant preparation preferably in a quantity of 1×10⁻⁸ to 5 weight percent, based on active protein. Preferably, the hydrolytic enzyme is contained in the liquid surfactant preparation from 0.001 to 5 wt. %, more preferably from 0.01 to 5 wt. %, even more preferably from 0.05 to 4 wt. % and particularly preferably from 0.075 to 3.5 wt. %. The hydrolytic enzyme can furthermore be covalently or non-covalently bound to a carrier and/or embedded in coating substances, e.g. to provide it with additional protection from premature inactivation. The protein concentration in the surfactant preparation can be determined with the aid of known methods, for example the BCA method (bicinchoninic acid; 2,2′-biquinolyl-4,4′-dicarboxylic acid) or the biuret method (A. G. Gornall, C. S. Bardawill and M. M. David, J. Biol. Chem., 177 (1948), pp. 751-766).

In another preferred embodiment, a surfactant preparation according to the invention is characterized in that the hydrolytic enzyme is a protease, amylase, cellulase, glycosidase, hemicellulase, mannanase, xylanase, xyloglucanase, xanthanase, pectinase, β-glucosidase, carrageenase or a lipase or a mixture which comprises at least two of these enzymes. More preferably, the hydrolytic enzyme is a lipase or a protease. Within the proteases, the hydrolytic enzyme is more preferably a serine protease, even more preferably a subtilase and particularly preferably a subtilisin. Most particularly preferably, the hydrolytic enzyme is a lipase. It has been shown that lipases are stabilized particularly well by the component stabilizing the hydrolytic enzyme in a surfactant preparation according to the invention. For washing or cleaning agents or disinfectants in particular, the storage stability of enzymes, and in particular also that of lipases, is a general problem. The same applies to the aforementioned proteases. Proteases are also stabilized particularly well by the component stabilizing the hydrolytic enzyme in a surfactant preparation according to the invention.

Examples of proteases are the subtilisins BPN′ from Bacillus amyloliquefaciens and Carlsberg from Bacillus licheniformis, the protease PB92, the subtilisins 147 and 309, the protease from Bacillus lentus, subtilisin DY and the enzymes classed as subtilases, but no longer as subtilisins in the narrower sense, thermitase, proteinase K and the proteases TW3 and TW7. Subtilisin Carlsberg is obtainable in a developed form with the trade name Alcalase® from the company Novozymes A/S, Bagsvwrd, Denmark. The subtilisins 147 and 309 are marketed with the trade names Esperase® and Savinase® by the company Novozymes. The protease variants sold with the name BLAP® are derived from the protease from Bacillus lentus DSM 5483. Other proteases that can be used are e.g. the enzymes obtainable with the trade names Durazym®, Relase®, Everlase®, Nafizym®, Natalase®, Kannase® and Ovozyme® from the company Novozymes, the enzymes obtainable with the trade names Purafect®, Purafect® OxP, Purafect® Prime, Excellase® and Properase® from the company Danisco/Genencor, the enzyme obtainable with the trade name Protosol® from the company Advanced Biochemicals Ltd., Thane, India, the enzyme obtainable with the trade name Wuxi® from the company Wuxi Snyder Bioproducts Ltd., China, the enzymes obtainable with the trade names Proleather® and Protease P® from the company Amano Pharmaceuticals Ltd., Nagoya, Japan, and the enzyme obtainable with the name Proteinase K-16 from the company Kao Corp., Tokyo, Japan. The proteases from Bacillus gibsonii and Bacillus pumilus, which are disclosed in the international patent applications WO 08/086,916 and WO 07/131,656, are also particularly preferably used. Other proteases which can be used advantageously are disclosed in the patent applications WO 91/02792, WO 08/007,319, WO 93/18140, WO 01/44452, GB 1243784, WO 96/34946, WO 02/029024 and WO 03/057246. Other proteases which can be used are those which are naturally present in the microorganisms Stenotrophomonas maltophilia, in particular Stenotrophomonas maltophilia K279a, Bacillus intermedius and Bacillus sphaericus.

Examples of amylases are the α-amylases from Bacillus licheniformis, from Bacillus amyloliquefaciens or from Bacillus stearothermophilus and in particular also their improved developments for use in washing or cleaning agents. The enzyme from Bacillus licheniformis is obtainable from the company Novozymes with the name Termamyl® and from the company Danisco/Genencor with the name Purastar®ST. Development products of these α-amylases are obtainable from the company Novozymes with the trade names Duramyl® and Termamyl®ultra, from the company Danisco/Genencor with the name Purastar®OxAm and from the company Daiwa Seiko Inc., Tokyo, Japan, as Keistase®. The α-amylase from Bacillus amyloliquefaciens is marketed by the company Novozymes with the name BAN®, and derived variants of the α-amylase from Bacillus stearothermophilus with the names BSG® and Novamyl®, likewise from the company Novozymes. Moreover, for this purpose the α-amylase from Bacillus sp. A 7-7 (DSM 12368) and the cyclodextrin-glucanotransferase (CGTase) from Bacillus agaradherens (DSM 9948) should be highlighted. Furthermore, the amylolytic enzymes which are disclosed in the international patent applications WO03/002711, WO03/054177 and WO07/079,938 can be used. Fusion products of all of the above molecules can also be used. In addition, the developments of α-amylase from Aspergillus niger and A. oryzae obtainable with the trade names Fungamyl from the company Novozymes are suitable. Other commercial products which can advantageously be used are e.g. Amylase-LT® and Stainzyme® or Stainzyme Ultra® or Stainzyme Plus®, the latter also from the company Novozymes. Variants of these enzymes obtainable by point mutations can also be used according to the invention.

Examples of cellulases (endoglucanases, EG) are the fungal, endoglucanase(EG)-rich cellulase preparation and developments thereof which are sold by the company Novozymes with the trade name Celluzyme®. The products Endolase® and Carezyme® also obtainable from the company Novozymes are based on 50 kD-EG and 43 kD-EG from Humicola insolens DSM 1800. Other commercial products from this company which can be used are Cellusoft®, Renozyme® and Celluclean®. It is also possible to use e.g. cellulases which are obtainable from the company AB Enzymes, Finland, with the trade names Ecostone® and Biotouch®, and which are at least partially based on 20 kD-EG from Melanocarpus. Other cellulases from the company AB Enzymes are Econase® and Ecopulp®. Other suitable cellulases are from Bacillus sp. CBS 670.93 and CBS 669.93, the one from Bacillus sp. CBS 670.93 being obtainable from the company Danisco/Genencor with the trade name Puradax®. Other commercial products from the company Danisco/Genencor which can be used are “Genencor detergent cellulase L” and IndiAge®Neutra.

Other preferred hydrolytic enzymes are those which are grouped under the term glycosidases (E.C. 3.2.1.X). These include in particular arabinases, fucosidases, galactosidases, galactanases, arabino-galactan galactosidases, mannanases (also referred to as mannosidases or mannases), glucuronosidases, agarase, carrageenases, pullulanases, β-glucosidases, xyloglucanases (xylanases), xanthanases and pectin-degrading enzymes (pectinases). Preferred glycosidases are also grouped under the term hemicellulases. Hemicellulases include in particular mannanases, xyloglucanases (xylanases), β-glucosidases and carrageenases and furthermore pectinases, pullulanases and β-glucanases. Pectinases are pectin-degrading enzymes, the hydrolytic pectin-degrading enzymes belonging in particular to the enzyme classes EC 3.1.1.11, EC 3.2.1.15, EC 3.2.1.67 and EC 3.2.1.82. The pectinases within the framework of the present invention also include enzymes with the names pectate lyase, pectin esterase, pectin demethoxylase, pectin methoxylase, pectin methyl esterase, pectase, pectinoesterase, pectin pectyl hydrolase, pectin depolymerase, endopolygalacturonase, pectolase, pectin hydrolase, pectin-polygalacturonase, endo-polygalacturonase, poly-α-1,4-galacturonide glycanohydrolase, endogalacturonase, endo-D-galacturonase, galacturan 1,4-α-galacturonidase, exopolygalacturonase, poly(galacturonate) hydrolase, exo-D-galacturonase, exo-D-galacturonanase, exopoly-D-galacturonase, exo-poly-α-galacturonosidase, exopolygalacturonosidase or exopolygalacturanosidase.

Examples of suitable enzymes in this respect are obtainable e.g. with the names Gamanase®, Pektinex AR® or Pectaway® from the company Novozymes, with the name Rohapec® B1L from the company AB Enzymes and with the name Pyrolase® from the company Diversa Corp., San Diego, Calif., USA. The β-glucanase obtained from Bacillus subtilis is obtainable with the name Cereflo® from the company Novozymes. Particularly preferred glycosidases or hemicellulases according to the invention are mannanases, which are marketed e.g. with the trade names Mannaway® by the company Novozymes or Purabrite© by the company Danisco/Genencor.

Examples of lipases or cutinases are the lipases originally obtainable from Humicola lanuginosa (Thermomyces lanuginosus) or developed therefrom, in particular those with the amino acid exchange D96L. They are marketed e.g. by the company Novozymes with the trade names Lipolase®, Lipolase®Ultra, LipoPrime®, Lipozyme® and Lipex®. A further lipase which can be used advantageously is obtainable with the trade name Lipoclean® from the company Novozymes. Moreover, for example the cutinases originally isolated from Fusarium solani pisi and Humicola insolens can also be used. Further lipases that can be employed are obtainable from the company Amano with the names Lipase CE®, Lipase P®, Lipase B®, or Lipase CES®, Lipase AKG®, Bacillis sp. Lipase®, Lipase AP®, Lipase M-AP® and Lipase AML®. From the company Danisco/Genencor, for example the lipases or cutinases whose starting enzymes were originally isolated from Pseudomonas mendocina and Fusarium solanii can be used. As further important commercial products, the preparations M1 Lipase® and Lipomax® originally marketed by the company Gist-Brocades (now Danisco/Genencor) and the enzymes marketed by the company Meito Sangyo KK, Japan, with the names Lipase MY-30®, Lipase OF® and Lipase PL® should also be mentioned, and furthermore the product Lumafast® from the company Danisco/Genencor.

The enzymes to be used within the framework of the present invention can originate e.g. from microorganisms, for instance from the genera Bacillus, Streptomyces, Humicola or Pseudomonas, and/or can be produced by suitable microorganisms by biotechnological methods which are known per se, for instance by transgenic expression hosts, e.g. from the genera Escherichia, Bacillus, or by filamentous fungi. It is emphasized that they can also be in particular industrial enzyme preparations of the respective enzyme, i.e. accompanying substances can also be present. The enzymes can therefore be formulated and used together with accompanying substances, for instance from fermentation, or with other stabilizers.

Enzyme stabilizing within the meaning of the invention is present when the presence of the component stabilizing the hydrolytic enzyme has the effect that a surfactant preparation comprising hydrolytic enzyme and component stabilizing the hydrolytic enzyme (surfactant preparation according to the invention) has a higher enzymatic activity of the hydrolytic enzyme after storage in comparison to a control preparation which differs from the surfactant preparation according to the invention only by the absence of the component stabilizing the hydrolytic enzyme (control). In this respect, the boric acid is contained in the surfactant preparation according to the invention in a quantity of 0.1 to 2.49 wt. %, the propylene glycol in a quantity of 2 to 8 wt. % and the phenylboronic acid derivative in a quantity of 0.009 to 0.01 wt. %. After storage, the surfactant preparation according to the invention therefore has a higher residual activity of the hydrolytic enzyme in comparison to the control, the preparation according to the invention and the control having the same initial enzymatic activity at the beginning of storage and both preparations being treated in the same way, in particular with respect to the storage conditions and the determination of enzyme activity. Increasingly preferably, the storage takes place for at least 1 week, 2 weeks, 3 weeks, 4 weeks and particularly preferably for 7 weeks. Also, the storage preferably takes place at temperatures of 20° C., 25° C. or 30° C.

In connection with this, the enzyme activity can take place—adapted to the particular type of enzyme—in the manner conventional in the art. Methods for determining activity are familiar to the person skilled in the art in the field of enzyme technology and are routinely used by him. Methods for determining protease activity are disclosed e.g. in Tenside, volume 7 (1970), pp. 125-132. Proteolytic activity can furthermore be determined by means of the release of the chromophore para-nitroaniline (pNA) from the substrate suc-L-Ala-L-Ala-L-Pro-L-Phe-p-nitroanilide (suc-AAPF-pNA). The protease cleaves the substrate and releases pNA. The release of the pNA causes an increase in extinction at 410 nm, of which the curve over time is a measure of enzymatic activity (cf. Del Mar et al., 1979). The measurement is conducted at temperatures of 25° C., at pH 8.6 and a wavelength of 410 nm. The measuring period is 5 min. with a measuring interval of 20 s to 60 s. The protease activity is preferably expressed in PU (protease units).

The lipase activity is determined in a manner conventional in the art, and preferably as described in Michael C. Schotz and Arlene S. Garfinkel, “A simple lipase assay using trichloroacetic acid” (Journal of Lipid Research, vol. 13, pages 824-826, November 1972). The activity determination described here is based on the fact that enzyme samples are incubated with a serum-activated solution which contains radioactively labeled glycerol trioleate ([2-³H]glycerol trioleate) as substrate for the lipase (cf. page 824, last paragraph of the right-hand column, and page 825, first paragraph of the left-hand column in the above-mentioned publication). The reaction is generally stopped after one hour using trichloroacetic acid (TCA) and then centrifuged. The radioactivity in the supernatant is measured, as a result of which the activity of the enzyme is determined with the aid of a standard curve.

Particularly preferably, the presence of enzyme stabilizing is established using a lipase-containing liquid surfactant preparation, which is stored for 7 weeks at temperatures of 30° C., and the residual lipolytic activity of which is determined as described above. Most particularly preferably, the presence of enzyme stabilizing is established as described in the example.

A surfactant preparation is to be understood within the framework of the present invention as any type of composition which contains at least one surfactant. Such a composition preferably contains a surfactant as described below.

All liquid or flowable presentations can be used as liquid surfactant preparations here. Preparations which can be poured and can have viscosities of up to several 10,000 mPas are “flowable” within the meaning of the present application. The viscosity can be measured using conventional standard methods (e.g. Brookfield LVT-II viscometer at 20 rpm and 20° C., spindle 3) and is preferably in the range of 5 to 10000 mPas. Preferred agents have viscosities of 10 to 8000 mPas, values of between 120 and 3000 mPas being particularly preferred. A liquid surfactant preparation within the framework of the present invention can therefore also take the form of a gel or paste, or can be present as a homogeneous solution or suspension, and can be e.g. sprayable or formulated in other conventional presentations.

A liquid surfactant preparation according to the invention can be used as such or after dilution with water, in particular for the cleaning of textiles and/or hard surfaces. Such a dilution can be readily prepared by diluting a measured quantity of the surfactant preparation in a further quantity of water in specific weight ratios of surfactant preparation: water and optionally shaking this dilution in order to ensure even distribution of the surfactant preparation in the water. Possible weight or volume ratios of the dilutions are from 1:0 surfactant preparation: water to 1:10000 or 1:20000 surfactant preparation: water, preferably from 1:10 to 1:2000 surfactant preparation: water.

A surfactant preparation within the meaning of the present invention can therefore also be the washing or cleaning liquor itself. Washing or cleaning liquor is understood as the working solution containing the washing or cleaning agents, which acts on textiles or fabrics (washing liquor) or hard surfaces (cleaning liquor) and thus comes into contact with the soils present on textiles or fabrics or hard surfaces. The washing or cleaning liquor is generally made when the washing or cleaning process begins and the washing or cleaning agent is diluted with water, e.g. in a washing machine or in another suitable container.

In a preferred embodiment, the surfactant preparation is a washing or cleaning agent or disinfectant. The washing agents include all conceivable types of washing agents, in particular washing agents for textiles, carpets or natural fibers. They can be intended for manual and/or also for machine use. The washing agents furthermore include washing auxiliaries which are added to the actual washing agent during the manual or machine washing of textiles in order to achieve an additional effect. The cleaning agents include all agents also occurring in all of the aforementioned presentations for the cleaning and/or disinfection of hard surfaces, manual and machine dishwashing agents, carpet cleaners, scouring agents, glass cleaners, toilet rim blocks etc. Finally, textile pre- and post-treatment agents are on the one hand those agents with which the laundry item is brought into contact before the actual wash, e.g. to dissolve stubborn stains, and on the other hand those which give the laundry item further desirable properties such as pleasant handle, freedom from wrinkles or low static charge in a step that follows the actual textile wash. The latter agents include, inter alia, fabric softeners. Disinfectants are e.g. hand disinfectants, surface disinfectants and instrument disinfectants, which can also occur in the above-mentioned presentations. A disinfectant preferably brings about a reduction of microbes by a factor of at least 10⁴, i.e. from an initial 10,000 viable microbes (so-called colony-forming units—CFUs), no more than a single one survives, viruses not being considered as microbes in this respect since they have no cytoplasm and no inherent metabolism. Preferred disinfectants bring about a reduction of microbes by a factor of at least 10⁵.

As surfactant(s), anionic, nonionic, zwitterionic and/or amphoteric surfactants can be used. From the point of view of application, mixtures of anionic and nonionic surfactants are preferred. The total surfactant content of the liquid surfactant preparation is preferably below 60 wt. % and particularly preferably below 45 wt. %, based on the total liquid surfactant preparation.

Suitable nonionic surfactants include alkoxylated fatty alcohols, alkoxylated fatty acid alkyl esters, fatty acid amides, alkoxylated fatty acid amides, polyhydroxy fatty acid amides, alkylphenol polyglycol ethers, amine oxides, alkyl polyglucosides and mixtures thereof.

As nonionic surfactants, preferably alkoxylated, advantageously ethoxylated, in particular primary alcohols with preferably 8 to 18 C atoms and on average 1 to 12 moles ethylene oxide (EO) per mole of alcohol are used, in which the alcohol residue can be linear or preferably methyl-branched in position 2 or can contain linear and methyl-branched residues in a mixture, as are usually present in oxo alcohol residues. In particular, however, alcohol ethoxylates with linear residues from alcohols of natural origin with 12 to 18 C atoms, for example from coconut, palm, tallow fatty or oleyl alcohol, and on average 2 to 8 EO per mole of alcohol are preferred. The preferred ethoxylated alcohols include e.g. C₁₂₋₁₄ alcohols with 3 EO, 4 EO or 7 EU, C₉₋₁₁ alcohols with 7 EO, C₁₃₋₁₅ alcohols with 3 EO, 5 EU, 7 EU or 8 EU, C₁₂₋₁₈ alcohols with 3 EO, 5 EO or 7 EO and mixtures of these, such as mixtures of C₁₂₋₁₄ alcohol with 3 EO and C₁₂₋₁₈ alcohol with 7 EO. The above degrees of ethoxylation represent statistical averages which can be a whole or a fractional number for a specific product. Preferred alcohol ethoxylates have a narrow homolog distribution (narrow range ethoxylates, NRE). In addition to these nonionic surfactants, fatty alcohols with more than 12 EU can also be used. Examples of these are tallow fatty alcohol with 14 EO, 25 EU, 30 EO or 40 EO. Nonionic surfactants which contain EO and PO groups together in the molecule can also be used according to the invention. Furthermore, a mixture of a (relatively highly) branched ethoxylated fatty alcohol and an unbranched ethoxylated fatty alcohol, such as e.g. a mixture of a C₁₆₋₁₈ fatty alcohol with 7 EU and 2-propylheptanol with 7 EO, is also suitable. Particularly preferably, the surfactant preparation contains a C₁₂₋₁₈ fatty alcohol with 7 EU or a C₁₃₋₁₅ oxo alcohol with 7 EU as nonionic surfactant.

The content of nonionic surfactants is preferably 3 to 40 wt. %, for preference 5 to 30 wt. % and in particular 7 to 20 wt. %, based in each case on the total surfactant preparation.

In addition to the nonionic surfactants, the surfactant preparation can also contain anionic surfactants. As anionic surfactant, sulfonates, sulfates, soaps, alkyl phosphates, anionic silicone surfactants and mixtures thereof are preferably used.

As surfactants of the sulfonate type, preferably C₉₋₁₃ alkylbenzenesulfonates, olefin sulfonates, i.e. mixtures of alkene and hydroxyalkane sulfonates and disulfonates, as obtained e.g. from C₁₂₋₁₈ monoolefins with a terminal or internal double bond by sulfonation with gaseous sulfur trioxide and subsequent alkaline or acidic hydrolysis of the sulfonation products, are suitable. C₁₂₋₁₈ alkane sulfonates and the esters of α-sulfo fatty acids (ester sulfonates), for example the α-sulfonated methyl esters of hydrogenated coconut, palm kernel or tallow fatty acids, are also suitable.

As alk(en)yl sulfates, the alkali salts and in particular the sodium salts of the sulfuric acid semiesters of C₁₂-C₁₈ fatty alcohols, e.g. from coconut fatty alcohol, tallow fatty alcohol, lauryl, myristyl, cetyl or stearyl alcohol or of C₁₀-C₂₀ oxo alcohols, and those semiesters of secondary alcohols with these chain lengths, are preferred. From the point of view of washing technology, the C₁₂-C₁₆ alkyl sulfates and C₁₂-C₁₅ alkyl sulfates as well as C₁₄-C₁₅ alkyl sulfates are preferred. 2,3-Alkyl sulfates are also suitable anionic surfactants.

The sulfuric acid monoesters of straight-chain or branched C₇₋₂₁ alcohols ethoxylated with 1 to 6 moles of ethylene oxide, such as 2-methyl-branched C₉₋₁₁ alcohols with on average 3.5 moles of ethylene oxide (EO) or C₁₂₋₁₈ fatty alcohols with 1 to 4 EO, are also suitable.

Other preferred anionic surfactants are soaps. Saturated and unsaturated fatty acid soaps are suitable, such as the salts of lauric acid, myristic acid, palmitic acid, stearic acid, (hydrogenated) erucic acid and behenic acid and in particular soap mixtures derived from natural fatty acids, for example coconut oil, palm kernel oil, olive oil or tallow fatty acids.

The anionic surfactants including soaps can be present in the form of their sodium, potassium or magnesium or ammonium salts. The anionic surfactants are preferably present in the form of their sodium salts. Other preferred counterions for the anionic surfactants are also the protonated forms of choline, triethylamine or methylethylamine.

The anionic surfactant content of a surfactant preparation can be 1 to 40 wt. %, preferably 5 to 30 wt. % and most particularly preferably 10 to 25 wt. %, based in each case on the total surfactant preparation.

In another embodiment, the surfactant preparation is characterized in that it furthermore comprises at least one further ingredient, which is selected from the group consisting of builder, non-aqueous solvent, acid, water-soluble salt, thickener, disinfecting ingredient and combinations thereof.

The addition of one or more of the further ingredient(s) proves advantageous, since it results in further improved cleaning performance and/or disinfection being achieved. The improved cleaning performance and/or disinfection is preferably based on a synergistic combined action of at least two ingredients. This synergy can be achieved in particular by the combination of the hydrolytic enzyme, preferably a lipase or a protease, in particular a lipase, with one of the builders described below and/or with one of the non-aqueous solvents described below and/or with one of the acids described below and/or with one of the water-soluble salts described below and/or with one of the thickeners described below and/or with one of the disinfecting ingredients described below.

As builders that can be contained in the surfactant preparation, in particular silicates, aluminum silicates (in particular zeolites), carbonates, salts of organic di- and polycarboxylic acids and mixtures of these substances should be mentioned.

Organic builders which can be present in the surfactant preparation are e.g. the polycarboxylic acids that can be used in the form of their sodium salts, wherein polycarboxylic acids are understood to be those carboxylic acids which carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), methyl glycine diacetic acid (MGDA) and derivatives and mixtures thereof. Preferred salts are the salts of polycarboxylic acids, such as citric acid, adipic acid, succinic acid, glutaric acid, tartaric acid, sugar acids and mixtures thereof.

Polymeric polycarboxylates are also suitable as builders. These are e.g. the alkali metal salts of polyacrylic acid or polymethacrylic acid, for example those with a relative molecular mass of 600 to 750,000 g/mol.

Suitable polymers are in particular polyacrylates, which preferably have a molecular mass of 1,000 to 15,000 g/mol. Owing to their superior solubility, the short-chain polyacrylates having molar masses of 1,000 to 10,000 g/mol, and particularly preferably of 1,000 to 5,000 g/mol, can in turn be preferred from this group.

Also suitable are copolymeric polycarboxylates, in particular those of acrylic acid with methacrylic acid and of acrylic acid or methacrylic acid with maleic acid. To improve the water solubility, the polymers can also contain allylsulfonic acids, such as allyloxybenzenesulfonic acid and methallylsulfonic acid, as monomers.

However, soluble builders, such as e.g. citric acid, or acrylic polymers with a molar mass of 1,000 to 5,000 g/mol, are preferably used in the liquid surfactant preparation.

The molar masses given for polymeric polycarboxylates are, within the meaning of this document, weight average molar masses Mw of the respective acid form, which were always determined by gel permeation chromatography (GPC) using a UV detector. The measurement took place here against an external polyacrylic acid standard, which gives realistic molecular weight values owing to its structural similarity with the polymers being investigated. These figures differ significantly from the molecular weight data for which polystyrenesulfonic acids are used as standard. The molar masses measured against polystyrenesulfonic acids are generally significantly higher than the molar masses given in this document.

Organic builder substances of this type can, if desired, be contained in quantities of up to 40 wt. %, in particular up to 25 wt. % and preferably of 1 wt. % to 8 wt. %. Quantities close to the above upper limit are preferably used in pasty or liquid surfactant preparations, in particular those containing water.

The surfactant preparations according to the invention are liquid and preferably contain water as the main solvent. In addition or alternatively, non-aqueous solvents can be added to the surfactant preparation. Suitable non-aqueous solvents encompass mono- or polyhydric alcohols, alkanolamines or glycol ethers, provided that they are miscible with water in the concentration range stated. The solvents are preferably selected from ethanol, n-propanol, i-propanol, butanols, glycol, propanediol, butanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, diisopropylene glycol monomethyl ether, diisopropylene glycol monoethyl ether, methoxytriglycol, ethoxytriglycol, butoxytriglycol, 1-butoxyethoxy-2-propanol, 3-methyl-3-methoxybutanol, propylene glycol t-butyl ether, di-n-octyl ether and mixtures of these solvents. However, it is preferred that the surfactant preparation contains a polyol as non-aqueous solvent. The polyol can in particular encompass glycerol, 1,2-propanediol, 1,3-propanediol, ethylene glycol, diethylene glycol and/or dipropylene glycol. The surfactant preparation particularly preferably contains a mixture of a polyol and a monohydric alcohol. Non-aqueous solvents can be used in the surfactant preparation in quantities of between 0.5 and 15 wt. %, but preferably less than 12 wt. %.

To establish a desired pH value, which does not inherently result from the mixture of the other components, the surfactant preparations can contain system-compatible and environmentally compatible acids, in particular citric acid, acetic acid, tartaric acid, malic acid, lactic acid, glycolic acid, succinic acid, glutaric acid and/or adipic acid, but also mineral acids, in particular sulfuric acid, or bases, in particular ammonium hydroxides or alkali hydroxides. pH regulators of this type are contained in the surfactant preparations in quantities of preferably no more than 20 wt. % and in particular of 1.2 wt. % to 17 wt. %.

A surfactant preparation within the meaning of the invention can also contain one or more water-soluble salts, which are used e.g. to adjust the viscosity. These can be inorganic and/or organic salts. Inorganic salts that can be used in this case are preferably selected from the group comprising colorless water-soluble halides, sulfates, sulfites, carbonates, hydrogen carbonates, nitrates, nitrites, phosphates and/or oxides of alkali metals, alkaline earth metals, aluminum and/or transition metals; ammonium salts can also be used. Particularly preferred here are halides and sulfates of alkali metals; preferably, therefore, the inorganic salt is selected from the group comprising sodium chloride, potassium chloride, sodium sulfate, potassium sulfate and mixtures thereof. Organic salts that can be used are e.g. colorless water-soluble alkali metal, alkaline earth metal, ammonium, aluminum and/or transition metal salts of carboxylic acids. The salts are preferably selected from the group comprising formate, acetate, propionate, citrate, malate, tartrate, succinate, malonate, oxalate, lactate and mixtures thereof.

For thickening purposes, a surfactant preparation according to the invention can contain one or more thickeners. The thickener is preferably selected from the group comprising xanthan, guar, carrageenan, agar-agar, gellan, pectin, locust bean gum and mixtures thereof. These compounds are also effective thickeners in the presence of inorganic salts. In a particularly preferred embodiment, the surfactant preparation contains xanthan as thickener, since xanthan also thickens effectively in the presence of high salt concentrations and prevents a macroscopic separation of the continuous phase. In addition, the thickener stabilizes the continuous phase which is low in surfactant and prevents a macroscopic phase separation.

Alternatively or in addition, (meth)acrylic acid (co)polymers can also be used as thickeners. Suitable acrylic and methacrylic (co)polymers encompass e.g. the high molecular weight homopolymers of acrylic acid crosslinked with a polyalkenyl polyether, in particular an allyl ether of sucrose, pentaerythritol or propylene (INCI name according to “International Dictionary of Cosmetic Ingredients” from “The Cosmetic, Toiletry and Fragrance Association (CTFA)”: Carbomer), also referred to as carboxyvinyl polymers. These polyacrylic acids are obtainable inter alia with the trade names Polygel® and Carbopol®. In addition, e.g. the following acrylic acid copolymers are suitable: (i) copolymers of two or more monomers from the group of acrylic acid, methacrylic acid and their simple esters, preferably formed with C₁₋₄ alkanols (INCI Acrylates Copolymer), which are obtainable e.g. with the trade names Aculyn®, Acusol® or Tego® Polymer; (ii) crosslinked high molecular weight acrylic acid copolymers, which include for instance the copolymers of C₁₀₋₃₀ alkyl acrylates with one or more monomers from the group of acrylic acid, methacrylic acid and their simple esters, preferably formed with C₁₋₄ alkanols crosslinked with an allyl ether of sucrose or of pentaerythritol (INCI Acrylates/C₁₀₋₃₀ Alkyl Acrylate Crosspolymer) and which are obtainable e.g. with the trade name Carbopol®. Further suitable polymers are (meth)acrylic acid (co)polymers of the Sokalan® type.

It can be preferred for the surfactant preparation according to the invention to contain a (meth)acrylic acid (co)polymer in combination with a further thickener, preferably xanthan. The surfactant preparation can contain 0.05 to 1.5 wt. % and preferably 0.1 to 1 wt. %, based in each case on the total surfactant preparation, of thickener. The quantity of thickener used here is dependent on the type of thickener and the desired degree of thickening.

A disinfecting ingredient is understood in particular as ingredients which possess antimicrobial or antiviral efficacy, i.e. kill microbes. The microbicidal action depends on the content of the disinfecting ingredient in the surfactant preparation, the microbicidal action decreasing as the content of disinfecting ingredient decreases or the dilution of the surfactant preparation increases.

A preferred disinfecting ingredient is ethanol or propanol. Owing to their solvent properties and their microbicidal action, these monohydric alcohols are often used in disinfectants and also in cleaning agents in general. The term “propanol” here comprises both 1-propanol (n-propanol) and 2-propanol (“isopropanol”). Ethanol and/or propanol is contained in the surfactant preparation e.g. in a total quantity of 10 to 65 wt. %, preferably 25 to 55 wt. %. A further preferred disinfecting ingredient is tea tree oil. This is the essential oil of the Australian tea tree (Melaleuca alternifolia), an evergreen shrub which is native to New South Wales and Queensland from the genus of the paper-barks (Melaleuca), and other tea tree species from various genera (e.g. Baeckea, Kunzea and Leptospermum) in the myrtle family (Myrtaceae). Tea tree oil is obtained from the leaves and tips of the branches of these trees by steam distillation and is a mixture of approx. 100 substances; the main components include (+)-terpinen-4-ol, α-terpinene, terpinolene, terpineol, pinene, myrcene, phellandrene, p-cymene, limonene and 1,8-cineol. Tea tree oil is contained in the virucidal treatment solution e.g. in a quantity of 0.05 to 10 wt. %, preferably 0.1 to 5.0 wt. %. A further preferred disinfecting ingredient is lactic acid. Lactic acid or 2-hydroxypropionic acid is a fermentation product which is produced by various microorganisms. It has weak antibiotic activity. Lactic acid is contained in the surfactant preparation e.g. in quantities of up to 10 wt. %, preferably 0.2 to 5.0 wt. %.

Further disinfecting ingredients are e.g. active substances from the groups of the alcohols, aldehydes, antimicrobial acids or salts thereof, carboxylic acid esters, acid amides, phenols, phenol derivatives, diphenyls, diphenyl alkanes, urea derivatives, oxygen and nitrogen acetals and formals, benzamidines, isothiazoles and derivatives thereof, such as isothiazolines and isothiazolinones, phthalimide derivatives, pyridine derivatives, antimicrobial surface-active compounds, guanidines, antimicrobial amphoteric compounds, quinoline, 1,2-dibromo-2,4-dicyanobutane, iodo-2-propynyl butylcarbamate, iodine, iodophors and peroxides. Preferred active substances among these are preferably selected from the group comprising 1,3-butanediol, phenoxyethanol, 1,2-propylene glycol, glycerol, undecylenic acid, citric acid, lactic acid, benzoic acid, salicylic acid, thymol, 2-benzyl-4-chlorophenol, 2,2′-methylenebis(6-bromo-4-chlorophenol), 2,4,4′-trichloro-2′-hydroxydiphenyl ether, N-(4-chlorophenyl)-N-(3,4-dichlorophenyl)urea, N,N′-(1,10-decanediyldi-1-pyridinyl-4-ylidene)bis(1-octanamine)dihydrochloride, N,N′-bis-(4-chlorophenyl)-3,12-diimino-2,4,11,13-tetraazatetradecanediimidamide, quaternary surface-active compounds and guanidines. Preferred surface-active quaternary compounds contain an ammonium, sulfonium, phosphonium, iodonium or arsonium group. In addition, disinfecting essential oils can also be used, which at the same time provide perfuming of the virucidal treatment solution. However, particularly preferred active substances are selected from the group comprising salicylic acid, quaternary surfactants, in particular benzalkonium chloride, peroxo compounds, in particular hydrogen peroxide, alkali metal hypochlorite and mixtures thereof. A further disinfecting ingredient of this kind is contained in the surfactant preparation e.g. in a quantity of 0.01 to 1 wt. %, preferably 0.02 to 0.8 wt. %, in particular 0.05 to 0.5 wt. %, particularly preferably 0.1 to 0.3 wt. % and extremely preferably 0.2 wt. %.

Liquid surfactant preparations according to the invention in the form of conventional solvent-containing solutions are generally prepared by simply mixing the ingredients, which can be placed in an automatic mixer as the pure substance or as a solution.

Surfactant preparations according to the invention can contain only the hydrolytic enzyme as described. Alternatively, they can also contain further hydrolytic enzymes or other enzymes in a concentration which is useful for the effectiveness of the surfactant preparation. The invention therefore also provides surfactant preparations which furthermore encompass one or more further enzymes, it being possible in principle to use all enzymes that are established in the prior art for these purposes. As further enzymes, all enzymes which can develop a catalytic activity in a surfactant preparation according to the invention can preferably be used, in particular a protease, amylase, cellulase, hemicellulase, mannanase, tannase, xylanase, xanthanase, xyloglucanase, β-glucosidase, pectinase, carrageenase, perhydrolase, oxidase, oxidoreductase or a lipase, and mixtures thereof. Further enzymes are advantageously contained in the surfactant preparation in each case in a total quantity of 1×10⁻⁸ to 5 weight percent, based on active protein. Preferably, each further enzyme is contained in surfactant preparations according to the invention from 0.0001-1% and more preferably from 0.0005-0.5%, 0.001 to 0.1% and particularly preferably from 0.001 to 0.06 wt. %, based on active protein. Particularly preferably, the enzymes exhibit synergistic cleaning performances with respect to specific soils or stains, i.e. the enzymes contained in the surfactant preparation mutually support one another in their cleaning performance. Most particularly preferably, such synergy is present between a contained lipase and a further enzyme of an agent according to the invention, including in particular between the lipase and a protease and/or an amylase and/or a mannanase and/or a cellulase and/or a pectinase. Synergistic effects can occur not only between different enzymes, but also between one or more enzymes and further ingredients of the surfactant preparation according to the invention.

In a surfactant preparation according to the invention, the component stabilizing the hydrolytic enzyme can furthermore encompass at least one further enzyme stabilizer. Alternatively, one or two, preferably one, of the compounds which are provided as part of the component stabilizing the hydrolytic enzyme, i.e. boric acid, propylene glycol or an appropriate phenylboronic acid derivative, can be replaced by a further enzyme stabilizer. For example, a further enzyme stabilizer of this type is or comprises a polyol, in particular glycerol or 1,2-ethylene glycol, a sugar or sugar alcohol, a boric acid derivative, in particular aromatic boric acid esters, as disclosed e.g. in the international patent applications WO 92/119709 and WO 92/19708, an antioxidant, glyceric acid, calcium ions or calcium compounds, lactate or a lactate derivative, sulfonyl urea, imidazolium salt, 3,4-dichloroisocoumarin, 4-(2-aminoethyl)benzenesulfonyl fluoride hydrochloride, 4-amidinophenylmethanesulfonyl fluoride hydrochloride, antipain dihydrochloride, benzamidine hydrochloride, gabexate mesylate, trifluoroacetate, leupeptin, chymostatin or a peptide of the formula B2-B1-B0-R, in which R denotes hydrogen, —CH₃, —CX₃, CHX₂ or CH₂X and in which X is a halogen atom, B0 a phenylalanine residue with an —OH substituent at the p position and/or at the m position, B1 an individual amino acid residue, and B2 consists of one or more amino acid residues, optionally with a derivatized N-terminus, preferably such that there is a protective group at the N-terminus. Furthermore, it can be one or more of those enzyme-stabilizing compounds which are disclosed in the international patent applications WO 07/113,241 A1 or WO 02/008398 A1. The combined action of a component stabilizing the hydrolytic enzyme provided according to the invention and the further enzyme stabilizer preferably results in synergistic enzyme stabilizing.

The further enzyme stabilizer is preferably present in the surfactant preparation in a concentration of from 0.000001 to 10 wt. % and increasingly preferably from 0.00001 to 5.5 wt. %, from 0.000035 to 4.5 wt. %, from 0.00007 to 3.5 wt. % and from 0.0001 to 2.5 wt. %.

The invention also provides the use of a component which comprises boric acid, propylene glycol and a phenylboronic acid derivative with the structural formula

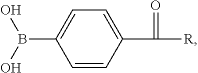

in which R denotes hydrogen, a hydroxyl group, a C₁-C₆ alkyl group, a substituted C₁-C₆ alkyl group, a C₁-C₆ alkenyl or a substituted C₁-C₆ alkenyl group, for stabilizing a hydrolytic enzyme in a liquid surfactant preparation.

As explained above, this component brings about an advantageous stabilizing of the hydrolytic enzyme in a liquid surfactant preparation. Particularly preferably, the phenylboronic acid derivative is 4-formylphenylboronic acid (4-FPBA). The hydrolytic enzyme is preferably a lipase or a protease, in particular a lipase.

All facts, subject matters and embodiments which are described for surfactant preparations according to the invention are also applicable to this subject matter of the invention. At this point, therefore, reference is explicitly made to the disclosure at the appropriate point with the indication that this disclosure also applies to the above use according to the invention.

The invention also provide a method in which a hydrolytic enzyme is stabilized in a washing liquor by a component stabilizing the hydrolytic enzyme, which comprises boric acid, propylene glycol and a phenylboronic acid derivative with the structural formula

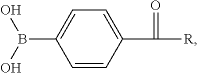

in which R denotes hydrogen, a hydroxyl group, a C₁-C₆ alkyl group, a substituted C₁-C₆ alkyl group, a C₁-C₆ alkenyl or a substituted C₁-C₆ alkenyl group. Particularly preferably, the phenylboronic acid derivative is 4-formyiphenylboronic acid (4-FPBA).

As explained above, this component brings about an advantageous stabilizing of the enzyme in a liquid surfactant preparation. Consequently, the hydrolytic enzyme is also stabilized in the corresponding washing or cleaning liquor, which is based on the liquid surfactant preparation. This is preferably a washing, cleaning or disinfection method. Particularly preferably, in such a method, a surfactant preparation is used as described above. The hydrolytic enzyme is preferably selected from the group consisting of protease, amylase, cellulase, glycosidase, hemicellulase, mannanase, xylanase, xyloglucanase, xanthanase, pectinase, β-glucosidase, carrageenase, lipase or mixtures thereof. Particularly preferably, the hydrolytic enzyme is a lipase or a protease, in particular a lipase.

A method according to the invention preferably takes place in a temperature range of between 10° C. and 60° C., in particular between 10° C. and 50° C., between 10° C. and 40° C., between 10° C. and 30° C. and particularly preferably between 15° C. and 30° C. Thermostable hydrolytic enzymes could be used at temperatures even higher than 60° C. in methods according to the invention, e.g. up to 70° C. or 75° C. The pH value at which a method according to the invention is advantageously carried out may depend on the item to be treated. For example, a surfactant preparation based on a cleaning agent for toilets advantageously has an acidic pH value, e.g. a pH value of between pH 2 and pH 5. A surfactant preparation which is based on a textile washing agent or a cleaning agent for other hard surfaces advantageously has a slightly acidic, neutral or alkaline pH, e.g. a pH value of between pH 6 and pH 11 or between pH 7 and pH 10. A surfactant preparation based on a manual dishwashing agent has a pH value e.g. of between pH 6.5 and pH 8. Consequently, it is also advantageous to carry out a method according to the invention at these respective pH values.

All facts, subject matters and embodiments which are described for surfactant preparations according to the invention are also applicable to this subject matter of the invention. At this point, therefore, reference is explicitly made to the disclosure at the appropriate point with the indication that this disclosure also applies to methods according to the invention.

The invention also provides a liquid enzyme preparation comprising a hydrolytic enzyme and a component stabilizing the hydrolytic enzyme, which is characterized in that the component stabilizing the hydrolytic enzyme comprises boric acid, propylene glycol and a phenylboronic acid derivative with the structural formula

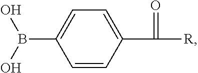

in which R denotes hydrogen, a hydroxyl group, a C₁-C₆ alkyl group, a substituted C₁-C₆ alkyl group, a C₁-C₆ alkenyl or a substituted C₁-C₆ alkenyl group.

It has been found that a component stabilizing the hydrolytic enzyme, as described above, also stabilizes a hydrolytic enzyme in a liquid preparation which does not encompass any surfactant. Consequently, by using such a component, hydrolytic enzymes can also be stabilized in a culture supernatant of a fermentation, during the workup of a culture supernatant of a fermentation or in a liquid enzyme preparation. Preferably, the boric acid is contained in a quantity of from 0.05 to 5.5 wt. % and increasingly preferably of from 0.075 to 4.5 wt. %, from 0.09 to 3.5 and from 0.1 to 2.49 wt. %, and/or the propylene glycol is contained in a quantity of from 0.000001 to 10 wt. % and increasingly preferably from 0.01 to 9.5 wt. %, from 1 to 9 wt. %, from 1.5 to 8.5 wt. % and from 2 to 8 wt. %, and/or the phenylboronic acid derivative is contained in a quantity of from 0.001 to 0.08 wt. % and increasingly preferably from 0.003 to 0.06 wt. %, from 0.005 to 0.05 wt. %, from 0.007 to 0.03 wt. % and from 0.009 to 0.01 wt. % in the enzyme preparation.

The hydrolytic enzyme is preferably contained in the enzyme preparation in a quantity of 1×10⁻⁸ to 5 weight percent, based on active protein. Furthermore the hydrolytic enzyme is preferably a lipase or a protease, in particular a lipase. All further facts, subject matters and embodiments which do not only apply exclusively to surfactant preparations according to the invention are consequently also applicable to this subject matter of the invention. At this point, therefore, reference is explicitly made to the disclosure at the appropriate point with the indication that this disclosure also applies to liquid enzyme preparations according to the invention.

Example: Stabilizing of a lipase in a liquid washing agent according to the invention

As the basic washing agent formulation, a liquid washing agent containing propylene glycol of the following composition was used (all figures in weight percent): 0.3-0.5% xanthan, 0.2-0.4% antifoam, 6-7% glycerol, 0.3-0.5% ethanol, 4-7% FAEOS (fatty alcohol ether sulfate), 24-28% nonionic surfactants, 1-2% sodium citrate (dihydrate), 2-4% soda, 14-16% coconut fatty acids, 0.5% HEDP (1-hydroxyethane-(1,1-diphosphonic acid)), 0-0.4% PVP (polyvinylpyrrolidone), 4-8% propylene glycol, 0-0.05% optical brightener, 0-0.001% dye, balance demineralized water.

Into this formulation, either 1 wt. % boric acid (Sigma Aldrich) alone or 1 wt. % boric acid and 4-formylphenylboronic acid (4-FPBA; Varata Chemicals Ltd., Shanghai, China) as stated below were incorporated as further constituents of the component stabilizing the hydrolytic enzyme (cf. table 1, relevant data in wt. %). Lipex 100L from the company Novozymes was used as lipase (quantity used 0.5 wt. %).

The storage took place over different lengths of time as stated in table 1 in airtight sealed vessels at 30° C. After storage, the residual lipolytic activity was determined in each case as described in Michael C. Schotz and Arlene S. Garfinkel, “A simple lipase assay using trichloroacetic acid” (Journal of Lipid Research, vol. 13, pages 824-826, November 1972). Here, the samples were incubated with a serum-activated solution which contained radioactively labeled glycerol trioleate ([2-³H] glycerol trioleate) as substrate for the lipase. The reaction was stopped after one hour using trichloroacetic acid (TCA) and then centrifuged. After measuring the radioactivity in the supernatant, the residual activity of the lipase was determined with the aid of a standard curve. The lipolytic activities obtained are given in Table 1 below, based on an initial activity of 100% at the beginning of storage.

TABLE 1
Determination of residual lipolytic activity after storage

| | | | Residual | Residual |
|---|---|---|---|---|
| Washing agent according | Boric | | activity 2 | activity |
| to basic formulation and | acid | Initial | weeks | 7 weeks |
| Lipase | + | 100% | 88% | 56% |
| Lipase + 0.004% 4-FPBA | + | 100% | not determined | 63% |
| Lipase + 0.02% 4-FPBA | + | 100% | 93% | 70% |
| Lipase | − | 100% | 6% | 0% |
| Lipase + 0.004% 4-FPBA | − | 100% | 42% | 10% |
| Lipase + 0.02% 4-FPBA | − | 100% | 67% | 47% |

It is clear that a component stabilizing the hydrolytic enzyme according to the invention brings about a significant improvement in enzyme stability in comparison to the control batches without such a component. This opens up the possibility to be able to use less boric acid as an enzyme stabilizer in liquid surfactant preparations.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A liquid surfactant preparation comprising a hydrolytic enzyme and a component stabilizing the hydrolytic enzyme, wherein the component stabilizing the hydrolytic enzyme comprises boric acid, propylene glycol and a phenylboronic acid derivative with the structural formula 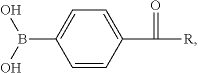
in which R denotes hydrogen, a hydroxyl group, a C₁-C₆ alkyl group, a substituted C₁-C₆ alkyl group, a C₁-C₆ alkenyl or a substituted C₁-C₆ alkenyl group.

2. The surfactant preparation according to claim 1, wherein the residue R in the phenylboronic acid derivative is a C₁-C₆ alkyl group or hydrogen.

3. The surfactant preparation according to claim 1, wherein the phenylboronic acid derivative is 4-formylphenylboronic acid.

4. The surfactant preparation according to claim 1, comprising 0.05 to 5.5 wt. % boric acid, 0.000001 to 10 wt. % propylene glycol, 0.001 to 0.08 wt. % phenylboronic acid derivative, and 1×10⁴ to 5 wt. % hydrolytic enzyme, based on active protein.

5. The surfactant preparation according to claim 1, wherein the hydrolytic enzyme is selected from a group of enzymes consisting of protease, amylase, cellulase, glycosidase, hemicellulase, mannanase, xylanase, xyloglucanase, xanthanase, pectinase, β-glucosidase, carrageenase or a lipase or a combination comprising at least two of the enzymes from the group.

6. The surfactant preparation according to claim 1, wherein the surfactant preparation further comprises at least one additional ingredient selected from the group consisting of builder, non-aqueous solvent, acid, water-soluble salt, thickener, disinfecting ingredient and combinations thereof.

7. A washing or cleaning method, in which a hydrolytic enzyme selected from the group consisting of protease, amylase, cellulase, glycosidase, hemicellulase, mannanase, xylanase, xyloglucanase, xanthanase, pectinase, β-glucosidase, carrageenase, lipase or mixtures thereof, is contacted in a washing liquor by a stabilizing component which comprises boric acid, propylene glycol and a phenylboronic acid derivative with the structural formula 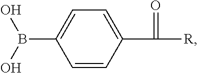
in which R denotes hydrogen, a hydroxyl group, a C₁-C₆ alkyl group, a substituted C₁-C₆ alkyl group, a C₁-C₆ alkenyl or a substituted C₁-C₆ alkenyl group.
